(19) United States
(12) Patent Application Publication
(10) Pub. No.: US 2017/0147962 A1
(43) Pub. Date: May 25, 2017

(54) METHOD AND SYSTEM FOR ASSIGNING SERVICE REQUESTS

(71) Applicant: Upstream Works Software Ltd., Vaughn (CA)

(72) Inventors: Ron Ijack, Vaughn (CA); Kevin Pickard, Vaughn (CA); Vivek Thomas, Vaughn (CA); Magda Nedelcu, Vaughn (CA); Tim Ellis, Vaughn (CA); Sean Snider, Vaughn (CA)

(21) Appl. No.: 14/952,059

(22) Filed: Nov. 25, 2015

(51) Int. Cl. G06Q 10/06

(52) U.S. Cl. CPC G06Q 10/063118

(57) ABSTRACT

Disclosed is a method of and system for managing service requests. The method may include determining, with a processor, a Service Level Agreement (SLA) target associated with each service request of a plurality of service requests. Additionally, the method may include determining, with a processor, a target delivery time corresponding to each service request of the plurality of service requests. A target delivery time of a service request may be determined based on each of an origin time and a SLA target associated with the service request. Furthermore, the method may include determining, with a processor, a priority value corresponding to each service request of the plurality of service requests. The priority value corresponding to a service request may be determined based on at least one of the origin time of the service request and the target delivery time of the service request.

### FIELD OF THE INVENTION

Generally, the disclosure relates to electrical computers and digital processing systems. More specifically, the disclosure relates to methods, systems and devices for assigning service requests to one or more agents.

### BACKGROUND

Businesses increasingly realize the importance of ensuring continued customer satisfaction in order to be successful. Customer satisfaction depends, to a large extent, on how service requests from the customers are processed and fulfilled. Ideally, service providers desire to respond to service requests from each and every customer at the earliest possible time. However, service providers often operate under business constraints such as, for example, a limited number of resources for processing service requests. As a result, service providers face a tremendous challenge in providing prompt response to service requests received from a large number of customers.

To address this challenge, Information Technology (IT) systems have been developed for facilitating management of service requests. Such systems typically utilize a queue for storing service requests before being assigned to resources such as agents. The queue generally functions on a First-In-First-Out (FIFO) principle. Accordingly, service requests received earlier in time may be given higher priority compared to service requests received later in time. To some extent, this ensures fairness in processing service requests from different customers based on how long the service requests have been waiting in the queue.

However, there are several scenarios where waiting time alone may not be sufficient to prioritize processing of service requests. For instance, other factors such as, for example, complexity of processing the service request, type of communication channel on which the service request was received, a business importance of the customer who generated the service request, expectations of the customer etc. may need to be considered.

Accordingly, there is a need for improved methods and systems for managing service requests.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed is a method of managing service requests. The method may include determining, with a processor, a Service Level Agreement (SLA) target associated with each service request of a plurality of service requests. Additionally, the method may include determining, with a processor, a target delivery time corresponding to each service request of the plurality of service requests. A target delivery time of a service request may be determined based on each of an origin time and a SLA target associated with the service request. Furthermore, the method may include determining, with a processor, a priority value corresponding to each service request of the plurality of service requests. The priority value corresponding to a service request may be determined based on one or more of the origin time of the service request and the target delivery time of the service request.

In some embodiments, the SLA target may include a time duration. Further, the target delivery time of the service request may include a sum of the origin time and the SLA target.

In some embodiments, the priority value corresponding to the service request may be determined based on a time duration elapsed since the origin time. Additionally, in some embodiments, the priority value may be determined further based on a ratio of the time duration elapsed to the SLA target. Further, in some embodiments, the priority value may be determined based on a percentage value of the ratio.

In some embodiments, the priority value corresponding to the service request may be determined based on a remaining time duration until the target delivery time. Further, in some embodiments, the priority value corresponding to the service request may be determined based on a time difference between a current time and the target delivery time.

In some embodiments, the method may further include assigning one or more service requests of the plurality of service requests to one or more agents based on one or more priority values associated with the one or more service requests.

In some embodiments, each service request of the plurality of service requests may be associated with a skill level. Further, each agent of the one or more agents may be associated with one or more skill levels. Accordingly, the assigning of a service request to an agent may be further based on a matching of the skill level associated with the service request to a skill level associated with the agent.

In some embodiments, the priority value corresponding to the service request may be determined based further on a business schedule. Additionally, in some embodiments, the target delivery time may be determined based further on the business schedule.

In some embodiments, the origin time may include a time when the service request was generated by a user. In some embodiments, the plurality of service requests may be included in a queue. Accordingly, in some embodiments, the origin time may include a time when the service request entered the queue. In some embodiments, the service request may be embodied in an electronic message. The electronic message may be one or more of an electronic mail (email), a Short Messaging Service (SMS) message and a chat message. Accordingly, in some embodiments, a header of the electronic message may include the origin time.

Also disclosed is a system for managing service requests. The system may include a processor and a memory communicatively coupled to the processor. The memory may be configured to store program code which when executed by the processor, may cause the system to determine a Service Level Agreement (SLA) target associated with each service request of a plurality of service requests. Further, execution of the program code may also cause the system to determine a target delivery time corresponding to each service request of the plurality of service requests. A target delivery time of a service request may be determined based on each of an origin time and a SLA target associated with the service request. Additionally, execution of the program code may also cause the system to determine a priority value corresponding to each service request of the plurality of service requests. A priority value corresponding to a service request may be determined based on one or more of the origin time of the service request and the target delivery time of the service request.

Both the foregoing brief overview and the following detailed description provide examples and are explanatory only. Accordingly, the foregoing brief overview and the following detailed description should not be considered to be restrictive. Further, features or variations may be provided in addition to those set forth herein.

For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a flow chart of a method of managing service requests according to various embodiments.

FIG. 2 illustrates a flow chart of a method of managing service requests according to various embodiments.

FIG. 3 illustrates a flow chart of a method of managing service requests according to various embodiments.

FIG. 4 illustrates a flow chart of a method of managing service requests according to various embodiments.

FIG. 5 illustrates a flow chart of a method of assigning service requests to one or more agents according to various embodiments.

FIG. 6 illustrates block diagram of a system for managing service requests in accordance with various embodiments.

FIG. 7 illustrates a block diagram of a routing server configured to perform the methods of FIG. 2-6.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of film production, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

According to some embodiments of the present disclosure relates to routing of service requests in a contact center. The service requests may be received on multiple communication channels such as email, chat, SMS etc. Further, the service requests may be stored in a queue waiting to be routed to one or more agents qualified for processing of the service requests. In some embodiments, service requests received on a type of channel may be stored on a corresponding queue. As a result, a plurality of queues corresponding to a plurality of communication channels may be maintained.

Further, according to some embodiments, the service requests may be associated with Service Level Agreements (SLAs). In particular, a service request may be associated with a target delivery time as specified by a corresponding SLA. For instance, the SLA may include a SLA target, such as a time period within which the service request should be responded to by a qualified agent. Accordingly, the target delivery time may be calculated by adding the SLA target to an origin time of the service request. In some embodiments, the origin time may be the time at which the service request, such as a chat or SMS, entered the queue. Alternatively, the origin time may be the time at which the service request, such as an email, was received by an email server of the contact center. Skill schedule could also be taken into consideration for some skills when determining target time. This will ensure time is calculated only when the center is open. Accordingly, consistent with embodiments, schedules can be created and assigned to skills.

Further, in some instances, the service request may also be associated with a skill level. In some instances, the skill level may indicate a domain of experience and a level of experience corresponding to an agent who may be qualified to respond to the service request. For example, the skill level may be indicated by keywords such as “Billing” and “Senior level”. Accordingly, an agent whose domain of experience is accounting with at least a “Senior level” of experience may be qualified to respond to the service request. Further, the SLA target associated with the service request may be determined based on the skill level associated with the service request. For instance, a service request associated with a “Billing” skill level may be provided with a shorter SLA target compared to a service request associated with a “General Enquiry” skill level.

As a result, each service request in the queue may be associated with a skill level and a target delivery time. Accordingly, a priority value may be associated with each service request based on one or more of the skill level and the target delivery time. Further, the priority value may be used for routing the service requests to qualified agents.

The service requests may be routed to qualified agents using one of two techniques: “SLA routing by time difference” and “SLA routing by percentage”.

According to “SLA routing by time difference”, service requests in the queue are prioritized according to how close they are to their respective target delivery times or how greatly they have exceeded their respective target delivery times. For example, if a service request with skill level “General enquiry” has a 4 hour SLA target and a service request with skill level “Billing” has a 1 hour target, a 3 hour old service request with skill level “General enquiry” may be equivalent to 1 hour old service request with skill level “Billing”.

According to “SLA routing by percentage”, service requests may be associated with priority values by calculating the time period spent in the queue as a percentage of the respective SLA target. Service requests that have waited for the highest percentage of their SLA target time period may be prioritized over other service requests. For example, if a task with skill level “General Enquiry” has a 4 hour SLA target and a service request with skill level “Billing” has a 1 hour target, a 2 hour old service request with skill level A is equivalent to 0.5 hour old service request with skill level “Billing”. In other words, both service requests may be at 50% of their allotted SLA target. In some embodiments, “SLA routing by percentage” may balance efficiency among skill levels ensuring that agents corresponding to all skill levels operate efficiently.

In an instance, SLA targets, specified in minutes or seconds, corresponding to different skill levels may be maintained in a table. Accordingly, a service request with a skill level may be assigned a corresponding SLA target. As a result, the service request may be required to be served to a qualified agent within the time period stipulated by the SLA target. A Graphical User Interface (GUI) may allow users, such as a supervisor, to define SLA targets corresponding to different skills levels in an intuitive fashion by specifying seconds, minutes or hours.

Further, each skill level may also be associated with a business schedule that determines which hours of the day are to be included in performing calculations corresponding to “SLA routing by time difference” and “SLA routing by percentage”. In some instances, only defined business hours may be included in the calculations.

When a service request enters the queue, the target delivery time for the service request may be calculated based on the SLA target for the skill level. Accordingly, the origin time, such as the arrival timestamp of the service request, may be determined and the SLA target may be added to the origin value to produce the target delivery time. In various embodiments, this may be taking business schedule into consideration. Accordingly, the service request may need to be delivered before the target delivery time in order to meet the SLA target.

Further, in performing these calculations, non-business hours may be excluded. For example, the skill level “Billing” may be associated with business hours from 9 AM to 6 PM and a SLA target of 4 hours. Accordingly, a service request with skill level “Billing” that entered the queue at 5 PM must be delivered by 12 PM the next day to meet its SLA target.

When an agent is available to process a service request, a lookup may be performed on all of the skill levels that the agent may be qualified to process. Accordingly, service requests corresponding to all eligible skill levels may be determined. Subsequently, a service request that has the highest priority value may be identified and routed to the agent.

According to “SLA routing by time difference”, each service request may be evaluated based on the difference in business hours between the current time and their respective target delivery times. The service request that is most over its target delivery time may be given the highest priority value. If no service requests are over their target delivery times, the service request with the least time left to achieve its SLA target may be given the highest priority value.

According to “SLA routing by percentage”, each service request may be evaluated by the percentage of their allotted SLA target that has been used up. The service request with the highest percentage of SLA target used may be given the highest priority value.

In some instances, a service request may initially be associated with a first skill level and subsequently be associated with a second skill level. Accordingly, due to a change in skill level, corresponding change in target delivery time may be recalculated. In a default configuration, the target delivery time may be calculated when the service request first enters the queue. Further, the target delivery time may not be changed when a skill level corresponding to the service request is modified. In other words, the service request may still held to its original target SLA. However, if recalculation option is enabled, a service request's target delivery time may be recalculated based on changes to skill level of the service request.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

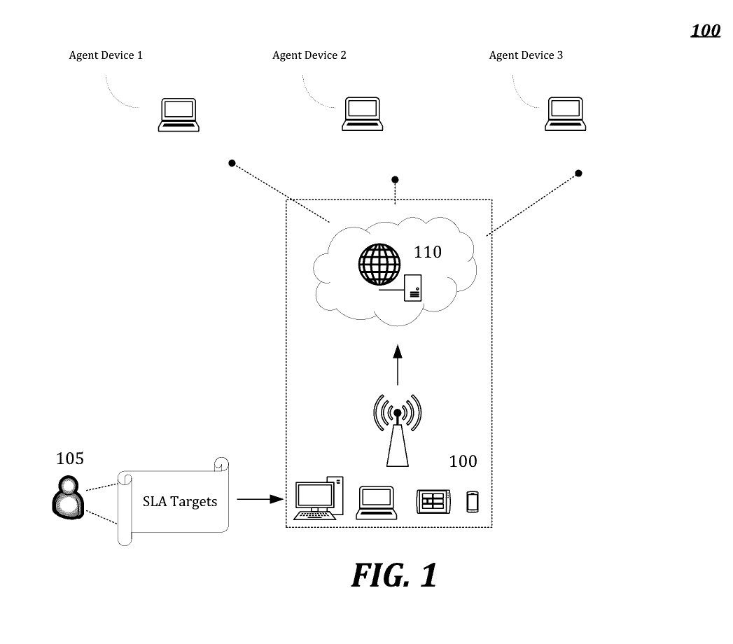

FIG. 1 illustrates one possible operating environment through which a platform consistent with embodiments of the present disclosure may be provided. The operating environment may comprise methods, systems, and devices collectively referred to as a platform. The platform may include a routing server 100 in communication with agent devices such as agent device 1-3. The communication may be performed over a network 110. Although the present disclosure refers to various functions and operations performed by particular components of the platform (e.g., routing server or agent devices), it should be understood that some platform components may be interchanged with others, and/or, where necessary, combined with other components to perform the functions and operations intended.

By way of non-limiting example, a routing platform 100 may be interconnected using a network 110. In some embodiments, network 110 may comprise a Local Area Network (LAN), a Bluetooth network, a Wi-Fi network and a cellular communication network. In other embodiments the routing platform may be hosted on a centralized server, such as, for example, a cloud computing service. A user 105 (e.g., a supervisor) may access platform 100 through a software application. The software application may be embodied as, for example, but not be limited to, a website, a web application, a desktop application, and a mobile application compatible with a routing server 100. One possible embodiment of the software application may be provided by a workflow management software executed on the routing platform 100 and remotely accessible using electronic devices such as laptop or tablet computers.

As will be detailed with reference to FIG. 1 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

The routing server 100 may be configured to communicate with each of agent devices 1-3 over the network 110. Further, the routing server 100 may be configured to provide a user interface to the user 105. Accordingly, the user 105 may interact with the routing server in order to control routing of service requests to the agent devices 1-3. For example, the routing server 100 may display a GUI to the user 105 in order to provide SLA target values corresponding to different skill levels of service requests. Further, the GUI may enable the user 105 to select one or more of “SLA routing by time difference” and “SLA routing by percentage”. Accordingly, service requests in the queue may be associated with priority values. Subsequently, service requests may be delivered to agent devices 1-3 over network 110 based on the priority values. As a result, service requests may be responded to according to their respective SLA targets.

### III. Platform Operation

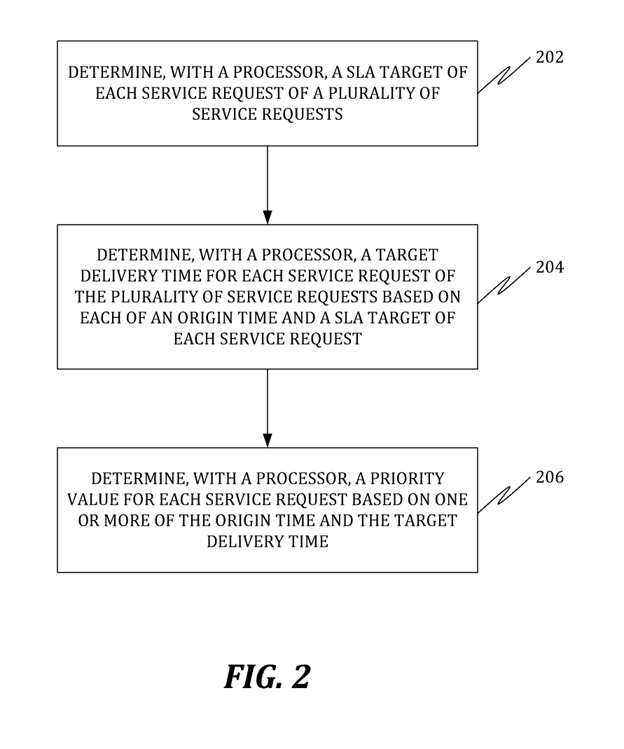

FIG. 2 illustrates a flow chart of a method of managing service requests. Generally, a service request is any communication from a customer that may be addressed to a service provider. For example, the service request may be embodied in an electronic message such as one or more of an electronic mail (email), a Short Messaging Service (SMS) message and a chat message. In some instances, each of the customer and the service provider may be one of an individual, a group of individuals, an organization and an Information Technology (IT) system. Further, in some instances, each of the customer and the service provider may be associated with different organizations. For example, the service provider may be a company providing technical support to customers who have purchased electronic equipment from the company. In some instances, each of the customer and the service provider may be associated with a common organization. For example, the customer may be an employee of an IT company while the service provider may be a technical support division of the IT company.

In some instances, the service request may be related to a service provided by the service provider. For example, the service request to a broadband internet provider may be a complaint regarding poor network connectivity. As another example, the service request to a telephone service provider may be a query related to the telephone bill. In some instances, the service request may be actionable. Accordingly, processing of the service request may include performing one or more actions in order to fulfill the service request. For example, if the service request includes a complaint, processing of the service request may include performing one or more actions in order to resolve the complaint. In some other instances, the service request may be non-actionable. For example, the service request may include a customer acknowledgement which may not require any responsive action to be performed by the service provider.

According to some embodiments, the platform of the present disclosure may be configured to manage service requests based on corresponding service level agreement (SLA). In general, a SLA associated with a service request is any information that may represent a manner in which one or more operations in relation to the service request may be performed. The one or more operations may include, but are not limited to, receiving, storing, processing and transmitting. The manner may generally indicate one or more of, but not limited to, when the one or more operations may be performed, a resource, such as an agent, that may perform the one or more operations, a place where the one or more operations may be performed, an amount of time that may be spent to perform the one or more operations and how the one or more operations may be performed.

In some embodiments, the SLA may represent an expectation of a customer who generated the service request. Accordingly, the SLA may be specified by the customer. Consequently, in some embodiments, the SLA may correspond to a customer satisfaction level. However, in some embodiments, the SLA may be specified by the service provider independent of an expectation of the customer.

Referring to FIG. 2, at step 202, a SLA target associated with each service request of a plurality of service requests may be determined using a processor. Accordingly, in some embodiments, each service may be previously associated with a corresponding SLA target. For instance, when the service request enters a queue, a SLA target may be associated with the service request. Accordingly, the service request may be instantiated as a queue object while the SLA target may be instantiated as metadata of the queue object.

In general, one or more factors may be considered while associating a SLA target to a service request. The one or more factors may include, but are not limited to, for example, a complexity level of the service request, a skill level of the service request, an importance of the customer who issued the service request, a type of service provided to the customer who issued the service request, a type of communication channel over which the service request was received and semantic content of the service request.

In some embodiments, a supervisor of a contact center may select the SLA targets corresponding to different kinds of service requests. For instance, a GUI of a workflow management software may be presented to the supervisor in order to receive the selection. For instance, the supervisor may be enabled to select different SLA targets for service requests corresponding to different channels of communications such as email, chat and SMS. Similarly, the supervisor may be enabled to select different SLA targets for service requests corresponding to different skill levels or complexity levels. Further, based on the selection made by the supervisor, service requests subsequently received may be automatically associated with corresponding SLA targets.

In some embodiments, the SLA target may be based on time. Accordingly, the SLA target may include a time period. Further, in some embodiments, the time period may be defined in relation to an origin time corresponding to the service request. For example, the SLA target may include the time period such as “2 hours”. Accordingly, in order to meet the SLA, it may be required to deliver the service request to an agent within the time period starting from the origin time. Alternatively, in some other embodiments, the SLA target may include a time instant. For example, the SLA target may include the time instant such as “5 PM Today”.

Further, in some embodiments, the SLA target may indicate a time constraint for not only delivering the service request to an agent but also a time constraint for processing the service request. For example, if the service request is in the form of an email including a billing related query, the SLA target may indicate a time period within which a response to the email should be sent. Accordingly, in some embodiments, a time period required by an agent to process or respond to a service request may be considered in associating the SLA target.

At step 204, a target delivery time corresponding to each service request of the plurality of service requests may be determined using a processor. In some embodiments, a target delivery time of a service request may be determined based on each of an origin time and a SLA target associated with the service request.

The origin time in general may represent a reference time instant for the SLA target. In some embodiments, the origin time may be the time instant when the service request was generated by a user. For example, consider the service request to be an email sent by a user at a time of 4 PM on Mar. 1, 2016. Accordingly, the time may be included in a header of the email in the form of a timestamp. In some instances, the email containing the service request may spend substantial amount of time on an email server prior to entering the queue. Therefore, by determining the origin time based on the timestamp in the email header, effect of delays between generation of the service request and entering of the service into the queue may be mitigated.

In some other embodiments, the origin time may be the time instant when the service request entered the queue. For example, consider the service request in the form of a chat message sent by a user. Due to the nature of chat based communication, there may be no substantial delays between generation of the chat message containing the service request and entering of the chat message into the queue.

In some other embodiments, the origin time may be arbitrarily specified independent of a time when the service request was generated or a time when the service request entered the queue. For example, the supervisor may be presented with a GUI to select the origin time corresponding to the service request.

In some embodiments, the origin time may be determined further based on a business schedule corresponding to the service request. The business schedule may include information indicating working days and working hours. For example, the business schedule may indicate working hours as 8 AM to 6 PM. Accordingly, when a service request is generated by a user during non-working hours, such as 6:30 PM, the origin time may be determined to be 8 AM on the next day.

In some embodiments, subsequent to determining the origin time of the service request, the target delivery time may be determined based on each of the origin time and the SLA target. In some embodiments, the target delivery time may indicate the time before which the service request should be delivered to an agent for processing. For example, the target delivery time may indicate the time before which the service request should be presented to an agent using a presentation device such as, for example, a display device. Alternatively, in some other embodiments, the target delivery time may indicate the time before which one or more responsive operations corresponding to the service request should be performed completely. For example, the target delivery time may indicate the time before which an agent should send a written response to the user who generated the service request.

In some embodiments, the target delivery time may be determined further based on a business schedule corresponding to the service request which may indicate working days and working hours. For example, a business schedule for service requests received over chat may indicate working hours to be 10 AM to 7 PM. Further, assuming a SLA target of 1 hour, if the service request arrived at 6:30 PM on a Monday, then the target delivery time may be determined to be 10:30 AM on the next day, i.e. Tuesday.

Further, in some embodiments, the target delivery time may be determined using a mathematical function of the origin time and the SLA target. In an instance, the target delivery time may be determined based on a temporal sum of the origin time and the SLA target. For instance, if the origin time of the service request is determined to be 10 AM with a SLA target of “2 hours”, the target delivery time may be determined by adding “2 hours” to 10 AM to obtain 12 PM.

Subsequently, at step 206, a priority value corresponding to each service request of the plurality of service requests may be determined using a processor. In some embodiments, a priority value corresponding to a service request may be determined based on one or more of the origin time of the service request and the target delivery time of the service request.

For instance, in some embodiments, the priority value corresponding to the service request may be determined based on a time duration elapsed since the origin time. For example, consider a first service request with an origin time of 10 AM and SLA target of “4 hours” to be present in the queue. Further, also consider a second service request with an origin time of 10:30 AM with a SLA target of “3 hours”. Accordingly, a target delivery time for the first service request may be calculated as 2 PM, while a target delivery time for the second service request may be calculated as 1:30 PM. Furthermore, assume that at 11 AM, an agent becomes available for processing service requests. Accordingly, priority values corresponding to each of the first service request and the second service request may be determined based on time duration elapsed since respective origin times. For example, for the first service request, a time duration elapsed since the corresponding origin time may be determined to be 1 hour. Similarly, for the second service request, a time duration elapsed since the corresponding origin time may be determined to be 30 minutes. Accordingly, in some embodiments, the first service request may be given a higher priority value than the second service request due to the greater time period elapsed since the origin time.

In some other embodiments, in addition to considering the time period elapsed since the origin time of a service request, the corresponding SLA target may also be considered in determining the priority value of the service request. For instance, the priority value may be determined further based on a ratio of the time duration elapsed to the SLA target. Continuing with the preceding example, for the first service request, a ratio of time duration elapsed since origin time (i.e. 1 hour) to the SLA target (i.e. 4 hours) may be determined as (1 hour)/(4 hours) i.e. 1/4. Similarly, for the second service request, the ratio may be determined as (30 minutes)/(3 hours) i.e. 1/6. Accordingly, the first service request may be given a higher priority value compared to that of the second service request since a greater portion of the SLA target has been elapsed in case of the first service request. Further, in some embodiments, the priority value may be determined based on a percentage value of the ratio. Continuing with the preceding example, the percentage value of elapsed time duration for the first service request may be determined to be 25% while that for the second service request may be determined to be 16.66%. Accordingly, a service request with a greater percentage value may be given a higher priority value than a service request with a lower percentage value.

In some instances, the time duration elapsed since the origin time for a service request may be greater than the corresponding SLA target. Accordingly, in such cases, the priority value for the service request may be determined proportional to the extent to which the time duration elapsed has exceeded the SLA target.

In some other embodiments, the priority value corresponding to the service request may be determined based on a remaining time duration until the target delivery time. The time duration until the target delivery time may be positive or negative. Further, in some embodiments, the priority value corresponding to the service request may be determined based on a time difference between a current time and the target delivery time. Recalling from the preceding example, at 11 AM, the remaining time duration for the first service request to reach target delivery time may be determined to be 3 hours while the remaining time duration for the second service request may be determined to be 2.5 hours. Accordingly, in some embodiments, the second service request may be given higher priority value compared to the first service request.

Further, in some embodiments, the priority value corresponding to the service request may be determined based further on the business schedule. Accordingly, time related calculations for determining the priority value may exclude non-business days and hours.

Subsequently, in some embodiments, service requests in the queue may be delivered to one or more agents qualified to process the service requests based on the corresponding priority values. As a result, service requests may be delivered to one or more qualified agents according to their respective SLAs.

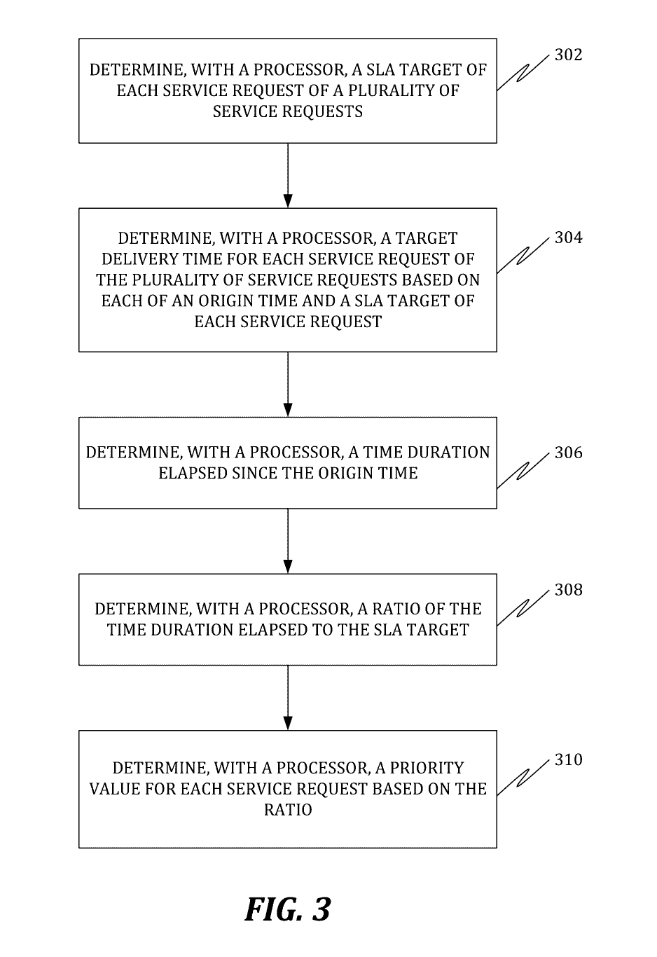

Turning now to FIG. 3, a flow chart of a method of managing service requests according to various embodiments is illustrated. At step 302, a SLA target of each service request of a plurality of service requests in the queue may be determined using a processor. Subsequently, at step 304, a target delivery time for each service request of the plurality of service requests may be determined using a processor.

The target delivery time may be determined based on each of an origin time and a SLA target of each service request. Thereafter, at step 306, a time duration elapsed since the origin time may be determined using a processor. For instance, the time duration elapsed from the origin time until a current time may be determined. Subsequently, at step 308, a ratio of the time duration elapsed to the SLA target may be determined using a processor. Further, a priority value for each service request may be determined, using a processor, based on the ratio. Accordingly, a service request with a greater ratio may be given higher priority over another service request with a smaller ratio. Thereafter, in some embodiments, service requests in the queue may be routed to qualified agents based on the respective priority values. As a result, service requests may be processed according to their respective SLAs.

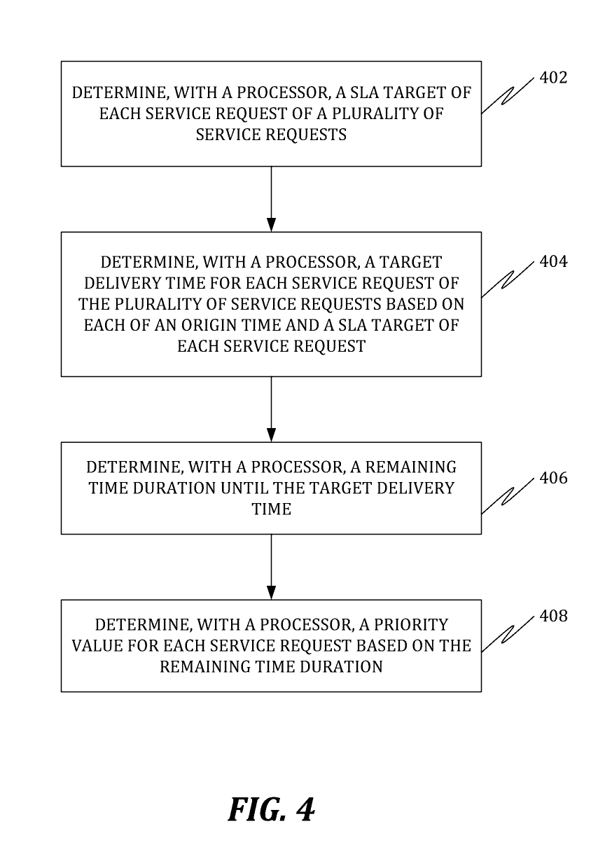

FIG. 4 illustrates a flow chart of a method of managing service requests according to various embodiments. At step 402, a SLA target of each service request of a plurality of service requests in the queue may be determined using a processor. Subsequently, at step 404, a target delivery time for each service request of the plurality of service requests may be determined using a processor. The target delivery time may be determined based on each of an origin time and a SLA target of each service request. Thereafter, at step 406, a remaining time duration until the target delivery time may be determined using a processor. Subsequently, at step 408, a priority value for each service request based on the remaining time duration may be determined using a processor. Accordingly, a service request with a smaller amount of time period left before corresponding target delivery time may be given higher priority value than another service request with a larger amount of time period left before corresponding target delivery time. Thereafter, in some embodiments, service requests in the queue may be routed to qualified agents based on the respective priority values. As a result, service requests may be processed according to their respective SLAs.

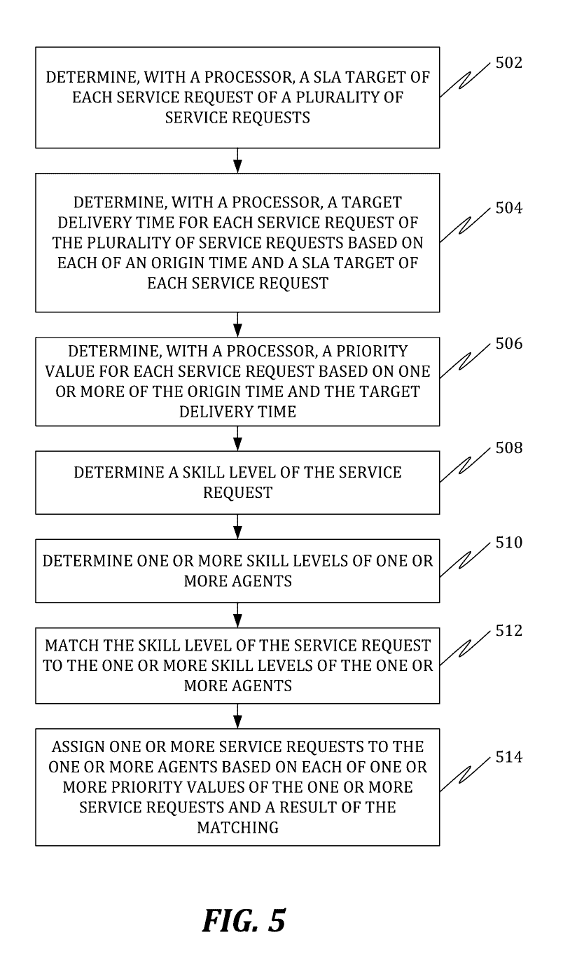

FIG. 5 illustrates a flow chart of a method of managing service requests according to various embodiments. At step 502, a SLA target of each service request of a plurality of service requests in the queue may be determined using a processor. Subsequently, at step 504, a target delivery time for each service request of the plurality of service requests may be determined using a processor. The target delivery time may be determined based on each of an origin time and a SLA target of each service request. Subsequently, at step 506, a priority value corresponding to each service request of the plurality of service requests may be determined using a processor. In some embodiments, a priority value corresponding to a service request may be determined based on one or more of the origin time of the service request and the target delivery time of the service request.

Thereafter, at step 508, a skill level of the service request may be determined. In some embodiments, the skill level may indicate a minimum qualification required by an agent to process the service request. For example, the skill level may indicate a domain experience such as, for example, billing, technical support and so on. In some instances, the skill level may be automatically assigned to the service request upon entering the queue. In other instances, a supervisor may manually assign the skill level to the service request. Further, in some embodiments, the skill level of the service request may be instantiated in the form of metadata of a queue object corresponding to the service request.

Subsequently, at step 510, one or more skill levels of one or more agents may be determined. In some instances, the one or more skill levels may be determined by performing a look up in a directory. Alternatively, in some other embodiments, a workflow management software may include a database containing information regarding skill levels of the one or more agents. Accordingly, the database may be accessed in order to determine the one or more skill levels.

Thereafter at step 512, the skill level of the service request may be matched to the one or more skill levels of the one or more agents using a processor. The matching may be performed by comparing. A result of the matching may be one of a success and a failure. If at least one skill level of an agent is identical to the skill level of the service request, then the result of matching may be determined to be a success. However, if no skill level of the agent is identical to the skill level of the service request, the result may be determined to be a failure.

Further, at step 514, one or more service requests may be assigned to the one or more agents based on each of one or more priority values of the one or more service requests and a result of the matching. For example, initially, one or more qualified agents may be identified based on the result of matching. Subsequently, one or more service requests may be identified from the queue based on respective priority values in order to be assigned to the one or more qualified agents. As a result, service requests may be processed according to their corresponding SLAs.

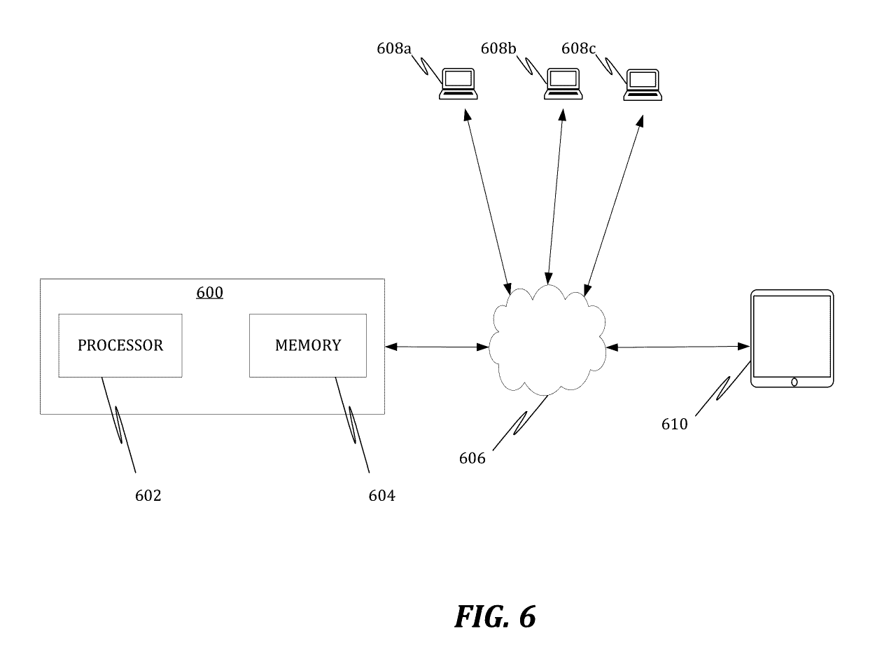

FIG. 6 illustrates a block diagram of a system 600 for managing service requests according to various embodiments. In some embodiments, the system 600 may include a routing server of a contact center. The system 600 may include a processor 602 and a memory 604. Further, the system 600 may be configured to communicate over a communication network 606 which may be an instance of network 110 as explained in conjunction with FIG. 1. Accordingly, in some embodiments, the system 600 may include a network interface module (not shown in figure). In some other embodiments, the communication network 606 may be an internal system bus. Additionally, the system 600 may be configured to communicate with one or more agent devices 608, such as 608a, 608b and 608c. Further, in some embodiments, the communication may take place over the communication network 606. Additionally, the system 600 may be configured to communicate with one or more customer devices such as 610 over the communication network 606. The customer device 610 may be operated by a customer who may generate a service request.

Further, the memory 604 may be communicatively coupled to the processor 602. Further, the memory 604 may be configured to store a program code which when executed by the processor, causes the system 600 to determine the Service Level Agreement (SLA) target associated with each service request of a plurality of service requests. Further, the program code, when executed, may cause the system 600 to determine the target delivery time corresponding to each service request of the plurality of service requests. The target delivery time of a service request may be determined based on each of the origin time and the SLA target associated with the service request. Additionally, the program code, when executed, may cause the system 600 to determine the priority value corresponding to each service request of the plurality of service requests. The priority value corresponding to a service request may be determined based on at least one of the origin time of the service request and the target delivery time of the service request. Further details about the methods that the system 100 may be configured to perform are explained in conjunction with FIG. 2-6.

While various embodiments of the disclosed methods and systems have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

### IV. Routing Server Architecture

Platform 100 may be embodied as, for example, but not be limited to, a website, a web application, a desktop application, and a mobile application compatible with a computing device. The routing server may comprise, but not be limited to, a desktop computer, laptop, a tablet, or mobile telecommunications device. Moreover, the platform 100 may be hosted on a centralized server, such as, for example, a cloud computing service. Although methods of FIG. 2-6 have been described to be performed by the routing server 100, it should be understood that, in some embodiments, different operations may be performed by different networked elements in operative communication with the routing server 100.

Embodiments of the present disclosure may comprise a system having a memory storage and a processing unit. The processing unit coupled to the memory storage, wherein the processing unit is configured to perform the stages of methods of FIG. 2-6.

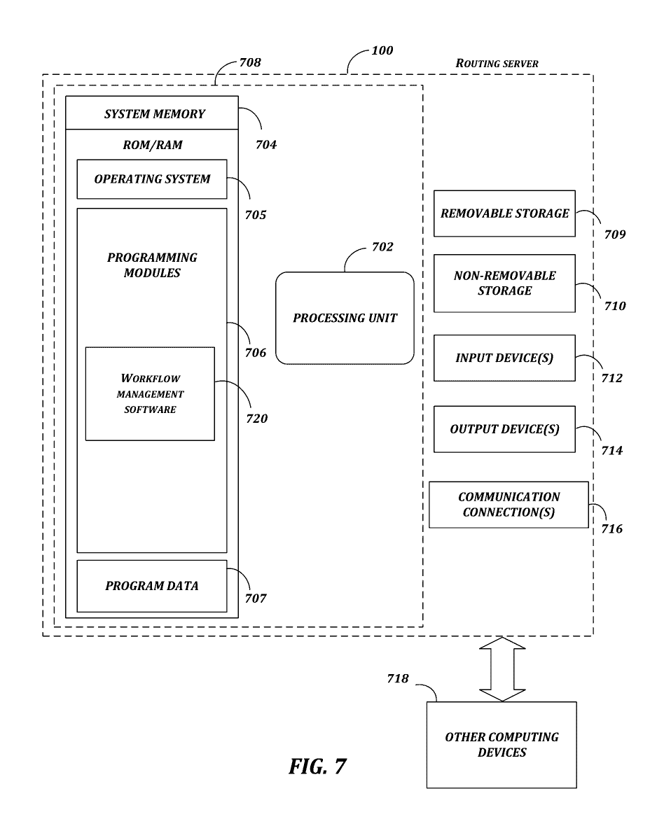

FIG. 7 is a block diagram of a system including routing server 100. Consistent with various embodiments of the disclosure, the aforementioned memory storage and processing unit may be implemented in a computing device, such as routing server 100 of FIG. 1. Any suitable combination of hardware, software, or firmware may be used to implement the memory storage and processing unit. For example, the memory storage and processing unit may be implemented with routing server 100 or any of other computing devices 718, in combination with routing server 100. The aforementioned system, device, and processors are examples and other systems, devices, and processors may comprise the aforementioned memory storage and processing unit, consistent with embodiments of the disclosure.

With reference to FIG. 7, a system consistent with various embodiments of the disclosure may include a computing device, such as routing server 100. In a basic configuration, routing server 100 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include a program data 707. Operating system 705, for example, may be suitable for controlling routing server 100's operation. In one embodiment, programming modules 706 may include a workflow management software 720. Furthermore, embodiments of the disclosure may be practiced in conjunction with a graphics library, other operating systems, or any other application program and is not limited to any particular application or system. This basic configuration is illustrated in FIG. 7 by those components within a dashed line 708.

Routing server 100 may have additional features or functionality. For example, routing server 100 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the routing server 100. Any such computer storage media may be part of the routing server 100. Routing server 100 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

Routing server 100 may also contain a communication connection 716 that may allow routing server 100 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 704, including operating system 705. While executing on processing unit 702, programming modules 706 (e.g., workflow management software 720) may perform processes including, for example, one or more stages of methods of FIG. 2-6 as described above. The aforementioned process is an example, and processing unit 702 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of managing service requests, the method comprising:
determining, with a processor, a Service Level Agreement (SLA) target associated with each service request of a plurality of service requests;
determining, with a processor, a target delivery time corresponding to each service request of the plurality of service requests, wherein a target delivery time of a service request is determined based on each of an origin time and a SLA target associated with the service request; and
determining, with a processor, a priority value corresponding to each service request of the plurality of service requests, wherein a priority value corresponding to a service request is determined based on at least one of the origin time of the service request and the target delivery time of the service request.

2. The method of claim 1, wherein the target delivery time of the service request comprises of a sum of the origin time and the SLA target, wherein the SLA target comprises a time duration.

3. The method of claim 1, wherein the priority value corresponding to the service request is determined based on a time duration elapsed since the origin time.

4. The method of claim 3, wherein the priority value is determined further based on a ratio of the time duration elapsed to the SLA target.

5. The method of claim 4, wherein the priority value is determined based on a percentage value of the ratio.

6. The method of claim 1, wherein the priority value corresponding to the service request is determined based on a remaining time duration until the target delivery time.

7. The method of claim 1, wherein the priority value corresponding to the service request is determined based on a time difference between a current time and the target delivery time.

8. The method of claim 1 further comprising assigning at least one service request of the plurality of service requests to at least one agent based on at least one priority value associated with the at least one service request.

9. The method of claim 8, wherein each service request of the plurality of service requests is associated with a skill level, wherein each agent of the at least one agent is associated with at least one skill level, wherein the assigning of a service request to an agent is further based on a matching of the skill level associated with the service request to a skill level associated with the agent.

10. The method of claim 1, wherein the plurality of service requests are comprised in a queue.

11. The method of claim 1, wherein the priority value corresponding to the service request is determined based further on a business schedule.

12. The method of claim 11, wherein the target delivery time is determined based further on the business schedule.

13. The method of claim 10, wherein the origin time comprises a time when the service request entered the queue.

14. The method of claim 1, wherein the origin time comprises a time when the service request was generated by a user.

15. The method of claim 1, wherein the service request is embodied in an electronic message, wherein the electronic message is at least one of an electronic mail (email), a Short Messaging Service (SMS) message and a chat message.

16. The method of claim 15, wherein a header of the electronic message comprises the origin time.

17. A system for managing service requests, the system comprising a processor and a memory communicatively coupled to the processor having stored therein a program code which when executed by the processor, causes the system to:
determine a Service Level Agreement (SLA) target associated with each service request of a plurality of service requests;
determine a target delivery time corresponding to each service request of the plurality of service requests, wherein a target delivery time of a service request is determined based on each of an origin time and a SLA target associated with the service request; and
determine a priority value corresponding to each service request of the plurality of service requests, wherein a priority value corresponding to a service request is determined based on at least one of the origin time of the service request and the target delivery time of the service request.

18. The system of claim 17, wherein the target delivery time of the service request comprises of a sum of the origin time and the SLA target, wherein the SLA target comprises a time duration.

19. The system of claim 17, wherein the priority value corresponding to the service request is determined based on a time duration elapsed since the origin time.

20. The system of claim 19, wherein the priority value is determined further based on a ratio of the time duration elapsed to the SLA target.

21. The system of claim 20, wherein the priority value is determined based on a percentage value of the ratio.

22. The system of claim 17, wherein the priority value corresponding to the service request is determined based on a remaining time duration until the target delivery time.

23. The system of claim 17, wherein the priority value corresponding to the service request is determined based on a time difference between a current time and the target delivery time.

24. The system of claim 17, wherein the processor is further configured to assign at least one service request of the plurality of service requests to at least one agent based on at least one priority value associated with the at least one service request.

25. The system of claim 24, wherein each service request of the plurality of service requests is associated with a skill level, wherein each agent of the at least one agent is associated with at least one skill level, wherein the assignment of a service request to an agent is further based on a match of the skill level associated with the service request to a skill level associated with the agent.

26. The system of claim 17, wherein the plurality of service requests are comprised in a queue, wherein the memory is further configured to store the queue.

27. The system of claim 17, wherein the priority value corresponding to the service request is determined based further on a business schedule.

28. The system of claim 27, wherein the target delivery time is determined based further on the business schedule.

29. The system of claim 26, wherein the origin time comprises a time when the service request entered the queue.

30. The system of claim 17, wherein the origin time comprises a time when the service request was generated by a user.

31. The system of claim 17, wherein the service request is embodied in an electronic message, wherein the electronic message is at least one of an electronic mail (email), a Short Messaging Service (SMS) message and a chat message.

32. The system of claim 31, wherein a header of the electronic message comprises the origin time.

33. A method of assigning a service request to an agent, the method comprising:
determining, using a processor, a Service Level Agreement (SLA) target associated with a service request;
determining, using a processor, an origin time corresponding to the service request;
determining, using a processor, a current time; and
assigning, using a processor, the service request to an agent based on each of the SLA target, the origin time and the current time.

34. The method of claim 33, wherein the SLA target comprises a time duration.

35. The method of claim 33 further comprising associating the service request with the SLA target based on a skill level of the service request, wherein the assigning of the service request is further based on each of the skill level of the service request and a skill level of the agent.

36. The method of claim 35, wherein the assigning comprises:
determining an elapsed time duration corresponding to the service request based on each of the origin time and the current time;
determining a relative elapsed time duration indicator corresponding to the service request based on each of the elapsed time duration and the SLA target, wherein the assigning of the service request to the agent is based on the relative elapsed time duration indicator.

37. The method of claim 36, wherein the relative elapsed time duration indicator comprises at least one of an integer value, a fractional value and a percentage value.

38. The method of claim 36, wherein the determining of the elapsed time duration is further based on a business schedule.

39. The method of claim 33, wherein the assigning comprises determining a remaining time duration corresponding to the service request based on each of the origin time, the current time and the SLA target, wherein the assigning of the service request to the agent is based on the remaining time duration.

40. The method of claim 7, wherein the determining of the remaining time duration is further based on a business schedule.

41. The method of claim 33, wherein the origin time comprises a time when the service request entered a queue.

42. The method of claim 33, wherein the origin time comprises a time when the service request was generated by a user.

43. The method of claim 33, wherein the service request is embodied in an electronic message, wherein the electronic message is at least one of an electronic mail (email), a Short Messaging Service (SMS) message and a chat message.

44. The method of claim 43, wherein a header of the electronic message comprises the origin time.
